(19) United States
(12) Patent Application Publication
(10) Pub. No.: US 2008/0040400 A1
(43) Pub. Date: Feb. 14, 2008

(54) SYSTEM AND METHOD FOR MANAGING LEGAL DOCUMENTS

(75) Inventors: Piao Yu, Tu-Cheng (TW); Cheng-Yi Huang, Tu-Cheng (TW); Chung-I Lee, Tu-Cheng (TW); Xin-Yu Huang, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/681,193

(22) Filed: Mar. 2, 2007

(30) Foreign Application Priority Data
Aug. 10, 2006 (CN) 200610200790.3

(51) Int. Cl. G06F 17/30

(52) U.S. Cl. 707/203; 707/E17.01

(57) ABSTRACT

The present invention provides a system for managing legal documents. The system includes: a document organizing module (10) for classifying and grouping the legal documents into classes, and for further classifying and grouping the legal documents in each of the classes into subclasses; an option extracting module (11) for extracting terms and conditions entries from the legal documents; a classification selection module (12) for selecting a class and a subclass of a new legal document; a subclass option manager (13) for selecting subclass entry options for the new legal document; a class option manager (14) for selecting class entry options for the new legal document; a new entry manager (15) for defining new entries and their attributes correspondingly for the new legal document; and a creating module (16) for creating the new legal document. A related method is also disclosed.

### BACKGROUND OF THE INVENTION

1. Field of the Invention

The present invention relates to a system and method for managing legal documents.

2. Description of Related Art

Modern complex commercial relationships involve multiple business partners and processes throughout the supply chain. This complexity affects terms and conditions entries corresponding to business liabilities, which relates to costs, shipments, payments, qualities, volume breaks, rebate policies, discounts, and so forth. Managing all of these (in particular if you have hosts of ever-changing partnerships) requires a serious commitment of time and resources. Today, a typical enterprise has to associate with a variety of vendors, suppliers, service providers, and such by using contracts, agreements, or other types of legal documents.

Legal documents are used in almost all areas of commerce. Most conventional legal documents are reviewed, accepted, and signed using an inefficient, manually irritating process. This seriously affects the efficiency of the businesses. In recent years, software programs related to legal document management have been adopted and used by many organizations. However, interfaces provided by the software programs are often text-based and cumbersome to use. Furthermore, the software programs also lack functionalities that allow legal document records to be efficiently created, updated, and shared.

What is needed, therefore, is a system and method that can provide management of legal documents throughout the stages of classifying, creating, maintenance, and analysis.

### SUMMARY OF THE INVENTION

A system for managing legal documents is provided. The system includes a document organizing module, an option extracting module, a classification selection module, a subclass option manager, a class option manager, a new entry manager, and a creating module. The document organizing module is configured for classifying and grouping the legal documents into classes, and for further classifying and grouping the legal documents in each of the classes into subclasses. The option extracting module is configured for extracting terms and conditions entries from the legal documents, and for setting the extracted terms and conditions entries as class entry options and subclass entry options. The classification selection module is configured for selecting a class and a subclass of a new legal document. The subclass option manager is configured for displaying the subclass entry options applicable to the subclass of the new document, and for selecting one or more subclass entry options from the displayed subclass entry options for the new legal document. The class option manager is configured for displaying the class entry options applicable to the class of the new document, and for selecting one or more class entry options from the displayed class entry options for the new legal document. The new entry manager is configured for defining one or more new entries and their attributes correspondingly for the new legal document. The creating module is configured for creating the new legal document by integrating the selected subclass entry options, the selected class entry options, and the new entries into the new legal document.

Furthermore, a method for managing legal documents is provided. The method includes the steps of: classifying and grouping the legal documents into classes, and classifying and grouping the legal documents in each of the classes into subclasses; extracting terms and conditions entries from the legal documents, and setting the extracted terms and conditions entries as class entry options and subclass entry options; selecting a class and a subclass of a new legal document; displaying the subclass entry options applicable to the subclass of the new document, and selecting one or more subclass entry options from the displayed subclass entry options for the new legal document; displaying the class entry options applicable to the class of the new document, and selecting one or more class entry options from the displayed class entry options for the new legal document; determining whether new entries need to be defined for the new legal document; defining one or more new entries and their attributes correspondingly for the new legal document if the new entries need to be defined; and creating the new legal document by integrating the selected subclass entry options, the selected class entry options, and the new entries into the new legal document.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is a schematic diagram of a hardware configuration of a system for managing legal documents in accordance with a preferred embodiment;

FIG. 2 is a schematic diagram of main software function modules of an application server of FIG. 1;

FIG. 3 is a schematic diagram of a classification system; and

FIG. 4 is a flowchart of a method for managing legal documents in accordance with a preferred embodiment.

### DETAILED DESCRIPTION OF THE INVENTION

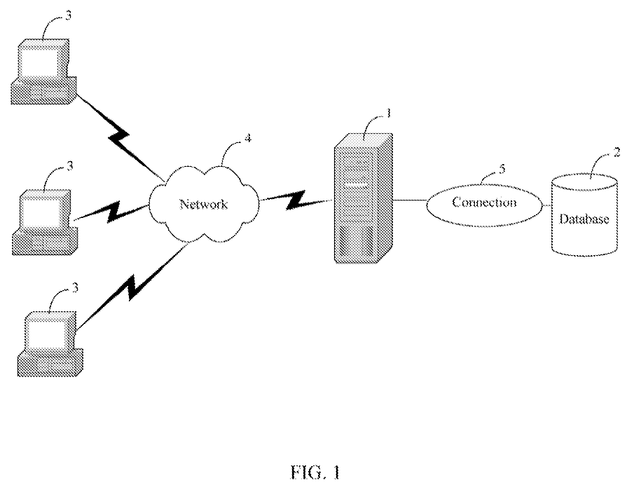

FIG. 1 is a schematic diagram of a hardware configuration of a system for managing legal documents (hereinafter, “the system”) in accordance with a preferred embodiment. The system includes an application server 1, a database 2, and a plurality of clients 3 (only three shown). The application server 1 communicates with the clients 3 via a network 4. The network 4 may be an intranet, the Internet, or any other types of communications link. Each of the plurality of clients 3 is configured (i.e., structured and arranged) for providing an interactive interface that enables users to perform relevant operations so as to manage the legal documents. The operations includes classifying the legal documents, creating new legal documents, and defining terms and conditions entries in the legal documents, and so on. The users may belong to different departments, such as a sales department, a purchasing department, a financial department, a legal department, or any other affiliates of an enterprise and/or a contracting party of the enterprise.

The application server 1 further connects to the database 2 via a connection 5. The database 2 is configured for storing different kinds of data, such as legal documents, terms and conditions of the legal documents, definitions of the terms and conditions, and so on. The connection 5 is a database connectivity, such as an open database connectivity (ODBC) or a Java database connectivity (JDBC).

The application server 1 is configured for managing the legal documents stored in the database 2, such as managing classification, edition, and creation of the legal documents. In the preferred embodiment, the legal documents are contracts, in other embodiments, the legal documents may be agreements, indictments, and responses to office actions, etc.

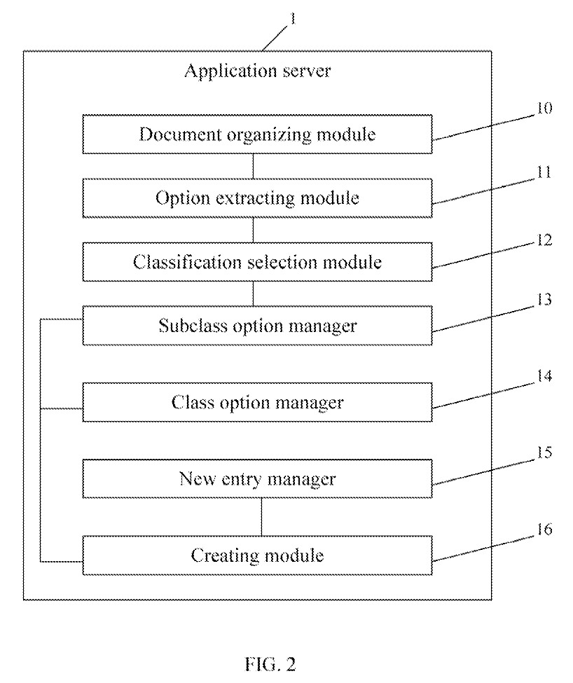

FIG. 2 is a schematic diagram of main software function modules of the application server 1. The application server 1 may include a document organizing module 10, an option extracting module 11, a classification selection module 12, a subclass option manager 13, a class option manager 14, a new entry manager 15, and a creating module 16.

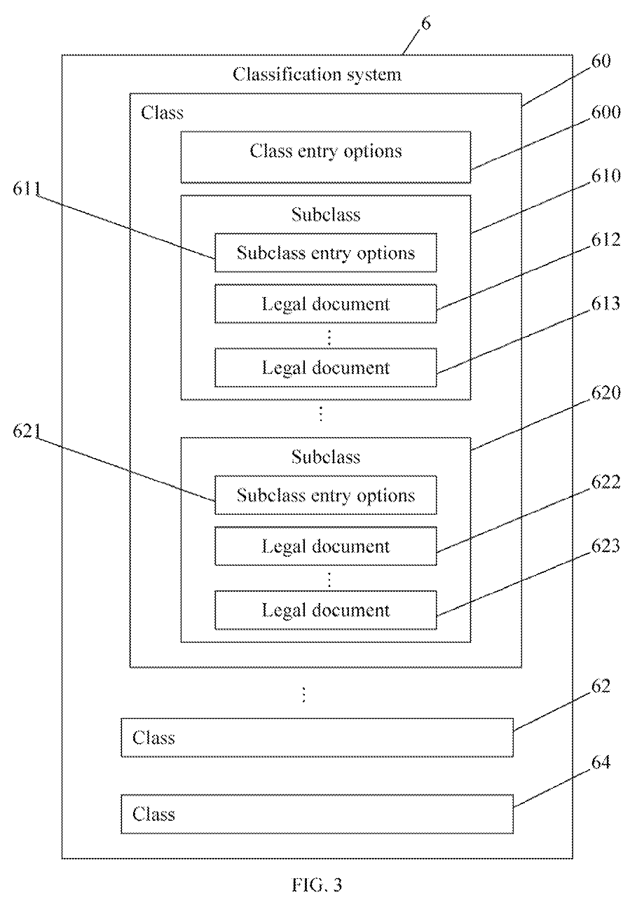

The document organizing module 1 0 is configured for constructing and applying a classification system for the legal documents by classifying and grouping the legal documents into classes in the classification system, and then further classifying and grouping the legal documents in each of the classes into subclasses (as shown in FIG. 3). For example, the legal documents (for example, contracts) may be classified and grouped into the following classes: lease contracts, project contracts, service contracts, employment agreements, manufacturing and supply agreements, business contracts, etc. Then, for another example, the legal documents in the lease contracts group (i.e., the lease contracts) may be classified and grouped into asset lease contracts, house lease contracts, equipment lease contracts, and so on; and the legal documents in the business contracts group (i.e., the business contracts) may be classified into fixed asset purchase contracts, exchange contracts, and software authorization contracts, etc.

The document organizing module 10 is further configured for organizing existed legal documents (if any) into the class and the subclass in the classification system. The existed legal documents may be finalized legal documents having been signed/approved by managers of the enterprise and the contracting party, may be the legal documents that are ready for review or approved, and may be other kinds of legal documents stored in the database 2.

The option extracting module 11 is configured for extracting terms and conditions entries from the legal documents (i.e., the finalized legal documents), and for setting extracted terms and conditions entries as class entry options and subclass entry options correspondingly. Each of the class entry options is applicable/insertable to the legal documents in a same class regardless of the subclass of the legal documents. Each of the subclasses entry options is applicable/insertable to the legal documents in a same subclass (described in detail below in relation to FIG. 3). If the database 2 does not have any legal documents to extract the class entry options and the subclass entry options from, the class entry options and the subclass entry options may be created through the option extracting module 11.

The classification selection module 12 is configured for selecting a class and a subclass of a new legal document. The subclass option manager 13 is configured for displaying all of the subclass entry options applicable to the subclass of the new document, and for selecting one or more subclass entry options from the displayed subclass entry options for the new legal document.

The class option manager 14 is configured for displaying all of the class entry options applicable to the class of the new document, and for selecting one or more class entry options from the displayed class entry options for the new legal document.

The new entry manager 15 is configured for defining/creating new entries for the new legal document. The new entry manager 15 is also configured for defining attributes of the new entries correspondingly. The new entries are neither subsets of the class entry options, nor subsets of the subclass entry options. The attributes may provide a range of data values such as dates or numbers selectable for the new entries.

The new entry manager 15 is further configured for inserting the new entries into the class entry options or the subclass entry options so as to expand the class entry options and the subclass entry options.

The creating module 16 is configured for creating the new legal document by integrating the selected subclass entry options, the selected class entry options, and the new entries into the new legal document.

The creating module 16 is also configured for exporting the created legal document, and submitting the created legal document for review and approval by the managers of the enterprise and the contracting party. The created legal document may be exported to a display, a memory (i.e., the application server 1, the database 2, and the clients 3), mailboxes or somewhere else as a PDF™ file, a WORD™ file, a TIFF file or other kinds of files. The creating module 16 is further configured for storing corresponding data into the database 2, such as the created legal document, the new entries, the attributes of the new entries, exported files, and so on.

FIG. 3 is a schematic diagram of a classification system. As shown, the classification system 6 is created by the document organizing module 10 for the legal documents. In the classification system 6, the legal documents are classified and grouped into multiple classes (only three shown), such as a class 60 (i.e., the business contracts), a class 62 (i.e., the service contracts), and a class 64 (i.e., the lease contracts). And then each of the classes is further classified and grouped into the subclasses (only two shown). For example, the class 60 has been classified and grouped into a subclass 610 and a subclass 620, wherein the subclass 610 may be the fixed asset purchase contracts, and the subclass 620 may be the exchange contracts.

Each class has a plurality of class entry options that are applicable/insertable to the legal documents in the same class regardless of the subclass of the legal documents. For example, the class 60 has class entry options 600. One of the class entry options 600 may be described as: all payments shall be made in U.S. dollars and are fixed amounts regardless of exchange rate fluctuations. The class entry option is applicable/insertable to a legal document 612, a legal document 613, a legal document 622, and a legal document 623.

Each subclass has a plurality of subclass entry options that are applicable/insertable to the legal documents of the same subclass, such as the subclass 610 has subclass entry options 611, and the subclass 620 has subclass entry options 621. For example, one of the subclass entry options 611 may be described as: all fees due and prices are net amounts due to A company, exclusive of all taxes, customs, duties, or other fees that may be governmentally imposed. The subclass entry option is just applicable/insertable to the legal document 612 and the legal document 613, but not applicable to the legal document 622 and the legal document 623.

The class entry options (i.e., the class entry options 600) and the subclass entry options (i.e., the subclass entry options 611 and the subclass entry options 621) are extracted from the legal documents in the database 2 by the option extracting module 11.

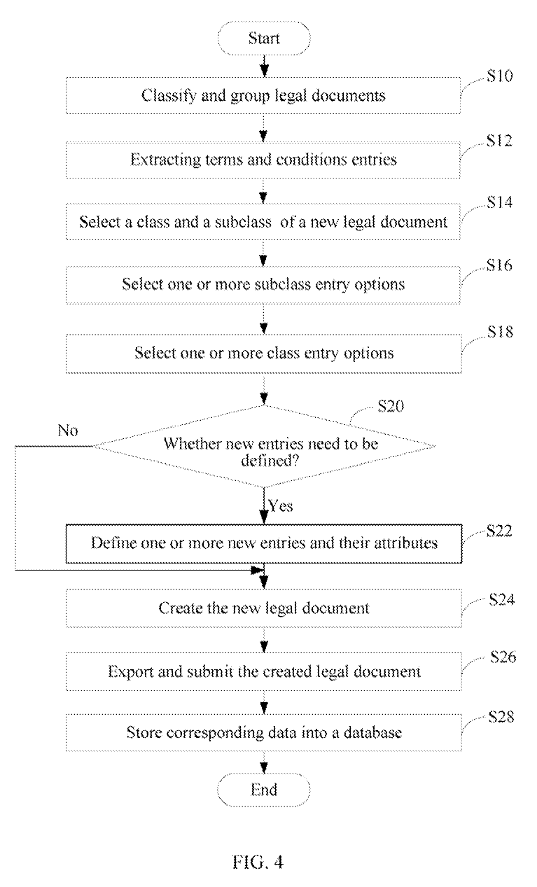

FIG. 4 is a flowchart of a method for managing legal documents. In step S10, the document organizing module 10 constructs a classification system to be applied on the legal documents by first classifying and grouping the legal documents into the classes in the classification system, and then further classifying and grouping the legal documents in each of the classes into the subclasses.

In step S12, the option extracting module 11 extracts the terms and conditions entries from the legal documents (i.e., the finalized legal documents), and sets the extracted terms and conditions entries as the class entry options and the subclass entry options correspondingly. Each of the class entry options is applicable/insertable to the legal documents in the same class regardless of the subclass of the legal documents. Each of the subclasses entry options is applicable/insertable to the legal documents of the same subclass (described in detail below in relation to FIG. 3). If the database 2 does not have any legal documents to extract the class entry options and the subclass entry options from, the class entry options and the subclass entry options may be created through the option extracting module 11.

In step S14, the class and the subclass of the new legal document are assigned/selected through the classification selection module 12. In step S16, the subclass option manager 13 displays all of the subclass entry options applicable to the subclass of the new document, and each of the displayed subclass entry options may be selected as the selected subclass entry options for the new legal document through the subclass option manager 13.

In step S18, the class option manager 14 displays all of the class entry options applicable to the class of the new document, and each of the displayed class entry options may be selected as the selected class entry options for the new legal document through the class option manager 14.

In step S20, the new entry manager 15 determines whether the new entries need to be defined/created for the new legal document. If the new entries need to be defined/created, in step S22, the new entry manager 15 defines/created one or more new entries and their attributes correspondingly for the new legal document. Afterwards, the new entry manager 15 may insert the new entries into the class entry options or the subclass entry options, so as to expand the class entry options and the subclass entry options. Otherwise, if the new entries do not need to be defined, the procedure directly goes to step S24.

In step S24, the creating module 16 creates the new legal document by integrating the selected subclass entry options, the selected class entry options, and the new entries into the new legal document.

In step S26, the creating module 16 exports the created legal document and submits the created legal document for review and approval by the managers of the enterprise and the contracting party. The created legal document may be exported as the PDF™ file, the WORD™ file, the TIFF file or other kinds of files.

In step S28, the creating module 1 6 stores corresponding data into the database 2, such as the created legal document, the defined entries, the attributes of the defined entries, exported files, and so on.

It should be emphasized that the above-described embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A system for managing legal documents, the system comprising:
a document organizing module configured for classifying and grouping the legal documents into classes, and for further classifying and grouping the legal documents in each of the classes into subclasses;
an option extracting module configured for extracting terms and conditions entries from the legal documents, and for setting the extracted terms and conditions entries as class entry options and subclass entry options;
a classification selection module configured for selecting a class and a subclass of a new legal document;
a subclass option manager configured for displaying the subclass entry options applicable to the subclass of the new document, and for selecting one or more subclass entry options from the displayed subclass entry options for the new legal document;
a class option manager configured for displaying the class entry options applicable to the class of the new document, and for selecting one or more class entry options from the displayed class entry options for the new legal document;
a new entry manager configured for defining one or more new entries and their attributes correspondingly for the new legal document; and
a creating module configured for creating the new legal document by integrating the selected subclass entry options, the selected class entry options, and the new entries into the new legal document.

2. The system as claimed in claim 1, wherein the class entry options are applicable to the legal documents in a same class regardless of the subclass of the legal documents.

3. The system as claimed in claim 1, wherein the subclass entry options are applicable to the legal documents in a same subclass.

4. The system as claimed in claim 1, wherein the creating module is further configured for storing corresponding data into a database.

5. The system as claimed in claim 1, wherein the creating module is further configured for exporting the created legal document, and for submitting the created legal document for review and approval.

6. The system as claimed in claim 1, wherein the insertion module is further configured for inserting the new entries into one of the class entry options and the subclass entry options.

7. A method for managing legal documents, the method comprising the steps of:
classifying and grouping the legal documents into classes, and classifying and grouping the legal documents in each of the classes into subclasses;
extracting terms and conditions entries from the legal documents, and setting the extracted terms and conditions entries as class entry options and subclass entry options;
selecting a class and a subclass of a new legal document;
displaying the subclass entry options applicable to the subclass of the new document, and selecting one or more subclass entry options from the displayed subclass entry options for the new legal document;
displaying the class entry options applicable to the class of the new document, and selecting one or more class entry options from the displayed class entry options for the new legal document;
determining whether new entries need to be defined for the new legal document;
defining one or more new entries and their attributes correspondingly for the new legal document if the new entries need to be defined; and
creating the new legal document by integrating the selected subclass entry options, the selected class entry options, and the new entries into the new legal document.

8. The method according to claim 7, further comprising the step of:
inserting the new entries into one of the class entry options and the subclass entry options.

9. The method according to claim 7, further comprising the step of:
exporting the created legal document and submitting the created legal document for review and approval.

10. The method according to claim 7, further comprising the step of:
creating the new legal document by integrating the selected subclass entry options and the selected class entry options into the new legal document if the new entries need not to be defined.

11. The method according to claim 7, wherein the class entry options are applicable to the legal documents in a same class regardless of the subclass of the legal documents.

12. The method according to claim 7, wherein the subclass entry options are applicable to the legal documents in a same subclass.

13. The method according to claim 7, wherein the defined terms and conditions entries are not subsets of the class entry options and the subclass entry options.
